(19) United States
(12) Patent Application Publication
(10) Pub. No.: US 2008/0012536 A1
(43) Pub. Date: Jan. 17, 2008

(54) Charging station for portable electronic instruments

(76) Inventor: Bruce A. Glass, Deerfield, IL (US)

Correspondence Address: MARK W. CROLL, 6 MULBERRY RD. EAST, DEERFIELD, IL, 60015, US

(21) Appl. No.: 11/825,710

(22) Filed: Jul. 9, 2007

Related U.S. Application Data
(60) Provisional application No. 60/830,027, filed on Jul. 11, 2006.

(51) Int. Cl. H02J 7/02

(52) U.S. Cl. 320/165

(57) ABSTRACT

A wall mounted charging station for Personal Electronic Instruments (hereinafter PEI's), such as cell phones PDA, earpieces and small computers, especially those having electrical wires to connect the PEI to a wall outlet for charging is described. The invention is a unique apparatus to accept and organize the charging cord of a PEI and provide a station for the convenient recharging of the battery associated with the PEI.

This patent application claims the priority of Provisional Patent Application Ser. No. 60/830,027 entitled Instrument Charging Station for Portable Electronic Devices, filed on Jul. 11, 2006.

### BACKGROUND OF THE INVENTION

The invention relates to wall mounted charging stations for Personal Electronic Instruments (hereinafter PEI's), especially those having electrical wires to connect the PEI to a wall outlet for charging. The invention is a unique apparatus to accept and organize the charging cord of a PEI and provide a station for the convenient recharging of the battery associated with the PEI.

The need to charge the batteries of portable electronic instruments (PEI's), such as cell phones, pagers, PDA's, MP3 players, computers, Blue Tooth ear pieces or other accessories is well known. Generally, each PEI comes with a transformer for transforming line voltage, generally 110 volts, 60 HZ in the U.S., to battery charging power, generally 2.5 to 10 volts DC. The transformer generally plugs into a standard wall outlet for the line power, and a thin electric cord, generally three feet to four feet in length extends to a proprietary plug for each manufacturer of PEI. The cord ends up being unsightly laid or looped on a counter or the floor.

### SUMMARY OF THE INVENTION

The invention provides a means for cleaning up the cords by providing an apparatus for coiling the cord and temporarily storing the PEI while it is being charged. The apparatus may or may not have a cover. Preferably the cover may be transparent or translucent, so that it provides a pleasing appearance, especially from a distance, but the owner of the PEI can verify that his PEI is in the charger and being charged. The visual check also acts as a reminder to take his PEI if he is leaving the area in which the PEI is being charged.

The invention provides a charging station for a portable electronic device or instrument having a charging cord comprising a substantially planar base having a top and a bottom and a pair of sides and means for mounting the base on a wall, a pocket mounted on the base, the pocket having a front wall and opposed side walls, a pair of spaced apart hooks adjacent the pocket, and a cover, the cover being made of translucent or transparent material and hinged adjacent the top or bottom or one side of the base and openable to allow access to the pocket.

The charging station may also provide an aperture in the base, the aperture adapted to allow the charging cord to pass there through. The charging cord may also pass between a slot located in either the base or the cover or both adjacent the base or cover.

One of the pair of hooks may have a stem projecting from the base and having a longitudinal axis and an arm extending at a right angle to the stem with the stem rotatable about the longitudinal access. The charging station may further comprise a third hook with the third hook adapted to hold keys. The charging station may also further comprise clips extending from the sidewalls of the pocket. The base has apertures located to accept the clips for detachably mounting the pocket on the base.

In one aspect of the invention, the cover may be opaque and the station may include an indicator light that signals the presence of a PEI in the station to be charged.

In another aspect, the invention provides a charging station for a portable electronic device having a charging cord comprising a substantially planar base having a top, a bottom and a pair of side edges, at least one first major aperture and a second minor aperture, the apertures located and adapted to mount the base over an electrical outlet on a wall, a pair of spaced apart hooks mounted on the base, and a pocket also mounted on the base with the pocket having a front wall and opposed side walls and adapted to hold a portable electronic instrument.

### BRIEF DESCRIPTION OF THE DRAWINGS

FIG. 1 is a perspective view of one embodiment of the invention mounted on a wall beside an electrical outlet.

FIG. 2 is a side view of one embodiment of the invention showing the cover partially open in faint line.

FIG. 3 is a perspective view of a second embodiment of the invention.

FIG. 4 is a perspective view of a third embodiment of the invention.

FIG. 5 is a top view of the base portion of the charging station shown in FIG. 4.

FIG. 6 is perspective view of a fourth embodiment of the invention.

FIG. 7 is a perspective view of a fifth embodiment of the invention.

The invention, together with further aspects, objects, features and advantages thereof will be more clearly understood from the following description taken in conjunction with the accompanying drawings in which the elements bear the same reference numerals throughout the various views.

### DESCRIPTION OF THE PREFERRED EMBODIMENTS

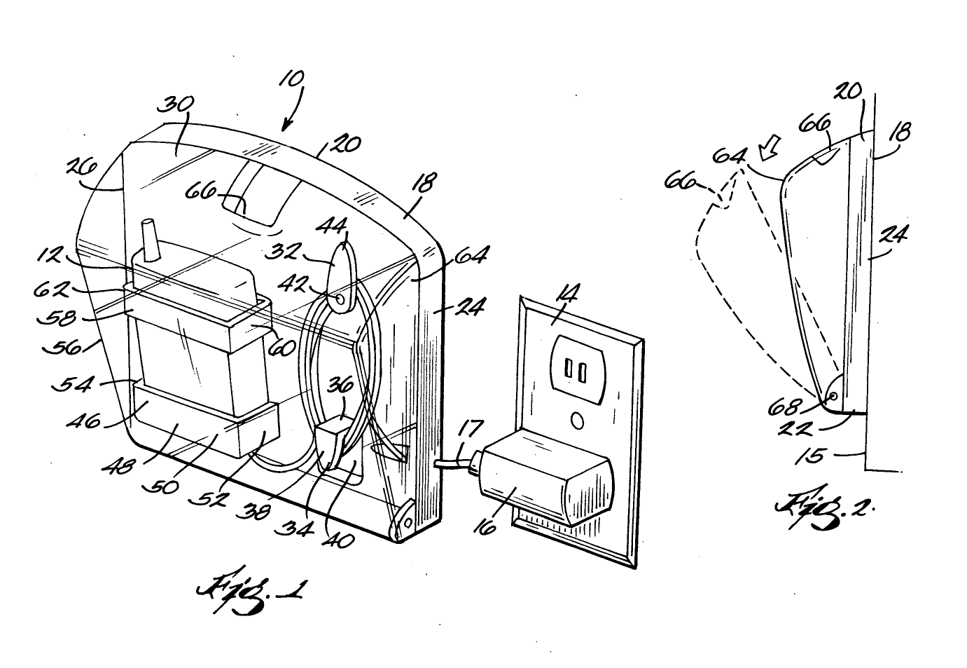

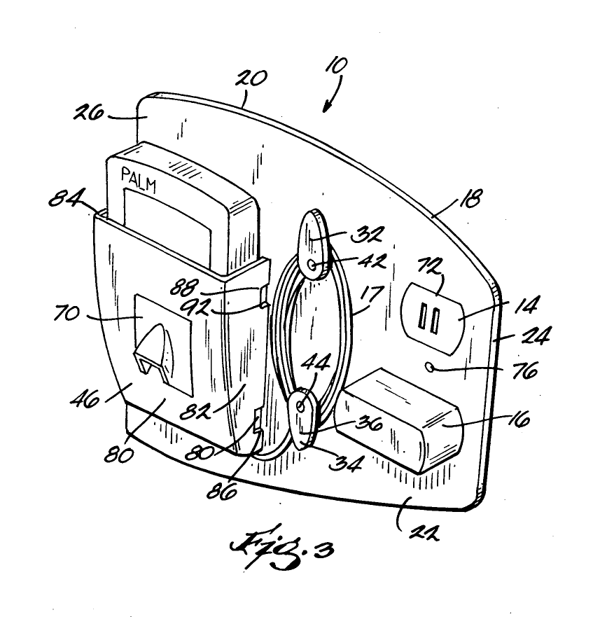

Referring generally to FIGS. 1 and 2, in one embodiment the charging station 10 for Personal Electronic Instruments (PEI's) 12 is generally shown vertically oriented and mounted on a wall 15 beside a standard 110 Volt electric outlet 14. The electric outlet 14 provides 110 Volt AC current at 60 HZ to a transformer 16 that is plugged into the outlet. The transformer transforms the electrical current from 120 Volts AC to 2.5 to 10 Volts DC to charge the battery (not shown) inside the PEI 12. The DC current travels through the cord 18 that extends from the transformer to a generally proprietary plug that plugs into a bottom or side of the PEI 12.

Transformers 16 have generally been provided with three to four feet of cord 17 in order to allow for their universal use in conjunction with the wall outlets 14. They are mounted near a floor or by a counter so that the associated a PEI can be laid on the counter or a table nearby for charging, generally, for at least an hour or so. The length of this cord has created an unsightly condition when the transformer is plugged into an outlet that is only a few inches above a countertop and the PEI has been laid on the countertop to be charged. The cord 17 generally snakes around the countertop or becomes tangled with other items laid on the countertop. Accordingly, there is a need for the organization of the cord 17 and a temporary storage location for the PEI 12 while it is being charged. The invention provides a unique apparatus for this purpose.

The charging station 10 comprises a base 18 constructed preferably of plastic material, such as polypropylene or polystyrene that, in the embodiment shown, has a top edge 20, a bottom edge 22 and a pair of side edges 24 and 26. The base can be mounted on the wall 15 by conventional means, such as screws extending through apertures or adhesive or double-sided sticky tape, or hook and loop type fasteners one associated with the wall and one associated with the back side of the base. Alternatively, the base can be set on the countertop and merely leaned up against the wall so that it is merely associated with the wall and not mounted thereto.

Appended on the front side 30 of the base 18 is a pair of hooks 32 and 34. In the embodiment shown, the lower hook has a fixed stem 36 and a fixed wing 38 extending substantially at a right angle to the stem 36. Beneath the wing 38 is a window 40 to provide for easier molding of the fixed hook 34.

The top hook, in the embodiment shown in FIG. 1, has a stem 42 that allows for the rotation of the wing 44. Either the stem itself can rotate about the base 18 or the wing 44 can rotate about the stem 42. In either event, the wing can rotate from the storage position shown in FIG. 1 wherein the wing 44 extends away from the opposed hook 34 to a release position in which the wing 44 extends toward the fixed hook 34. In the storage position, the cord 17 can be easily wound up on the hooks and stored. In the release position, the cord 17 can be easily removed from the pair of hooks if the cord 17 and transformer 16 need to be moved to another location.

Adjacent the pair of hooks is a PEI pocket 46. In the embodiment shown the pocket comprises a lower portion 48 having a front wall 50 and a pair of sidewalls 52 and 54. The pocket 46 also comprises an upper portion 56 also having a front wall 58 and a pair of sidewalls 60 and 62.

The pocket is adapted to hold the PEI, in this case, a cell phone. The cord 17 is plugged into the bottom of the cell phone while it is at least partially removed from the pocket and the cell phone is lowered into the pocket with the cord attached, or it can be plugged in after the phone is inserted into the pocket. Accordingly, the pocket has a bottom wall, not shown, that only extends partly across the sidewalls so the cord can extend through a portion of the bottom. The pocket 46 may have alternative slots or openings to allow for easy access to the plug at the end of the cord for attachment and detachment to the PEI 12. In other embodiments, the pocket may have a holder for the proprietary plug that renders the plug oriented in such a way that the cord is connected to the PEI 12 automatically when placing the PEI into the pocket 46.

The charging station 10 also comprises a cover 64. The cover has a handle 66 that allows the user to open the cover by rotating the cover about the hinge 68. In the embodiment shown in FIG. 1, the hinge is located adjacent the bottom edge 22 of the base 18. In operation, the user can rotate the cover 64 downward, the cord 17 can be attached to the PEI and the PEI can be slid into the pocket for charging. The cover is then rotated upward into the positions shown in FIG. 1 to create a pleasing appearance to the PEI user. The cover can be made of transparent or translucent material such as polystyrene so that the user of the PEI is aware that the PEI is in the station being charged. This acts as a visual reminder to the user to take the PEI with him when he leaves the area. The cover 64 can be made at least partially of a material that accepts dry marker for making notes by the user. Alternatively, it can have a clip or detent for holding a note pad or set of Post-It® notes.

In one embodiment, the charging station 10 also comprises an indicator light that signals the presence of a PEI in the station 10 to be charged. The light may be placed on the base 18, the pocket 46 or on the cover 64 and may be actuated by, for example, a switch activated by the placement of the PEI in the pocket 46, a switch signaling the cover 64 is fully closed or a switch sensing current in the cord 17.

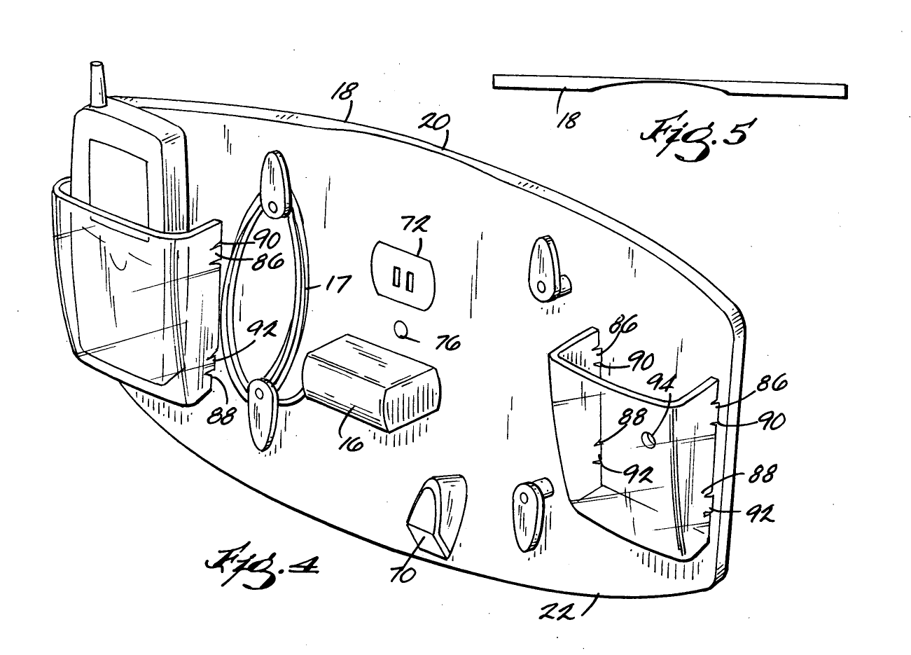

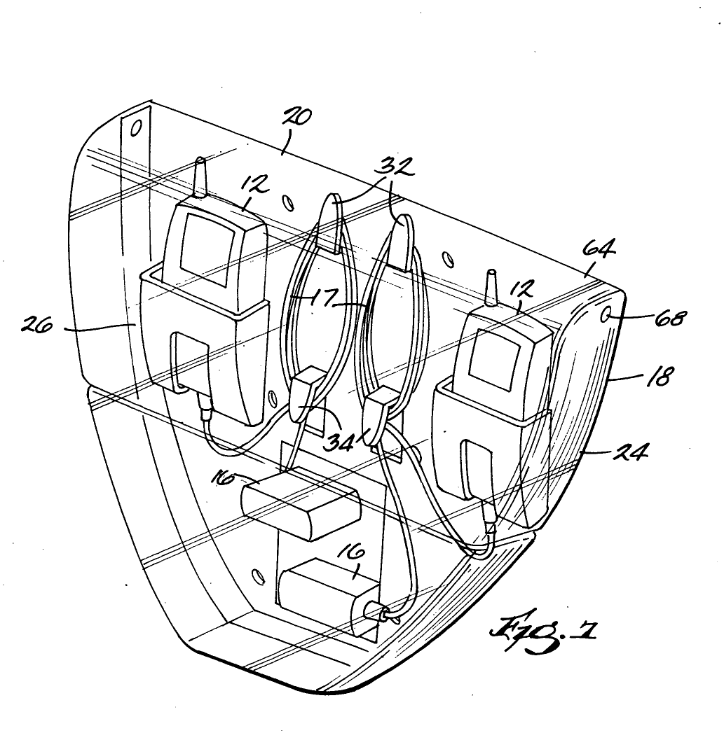

In one preferred embodiment, the station also comprises a third hook for holding other personal items such as the user's keys. Often times, keys and a PEI are kept together. By creating a charging station 10 that also provides for a temporary storage of keys, the two items can be closely associated and either one or the other is not left behind when the user leaves the area. The third hook 70 may be located in any of numerous locations. As seen in FIG. 3, the third hook 70 can be molded into the front wall 80 of the pocket 46. Alternatively, as shown in FIG. 4, the third hook 70 can be molded into the base in a manner similar to a stationary cord hook 34. Or, as seen in FIG. 6, the third hook 70 can be molded into the cover 64 especially the stationary central portion of the cover.

FIG. 3 shows a second embodiment of the charging station 10. In this embodiment, the base is elongated to also act as a cover for the electrical outlet 14. In this embodiment, there is no need for an aperture in the base 18 to allow the cord to go from the outlet 14 to the interior of the charging station, since the base of the charging station also acts as the cover for the outlet. The base has a pair of major apertures 72 and 74, only one of which is shown since the transformer 16 hides the second aperture. The base 18 also includes a minor aperture 76 that accepts a screw for holding the base 18 to the electrical outlet 14 and accordingly, the wall 15 (not shown in this view). In this embodiment, both hooks 36 and 42 are provided with means to allow the wings 34 and 44 to rotate about a longitudinal access extended through the respective stems 36 and 42. It is to be understood that either one or both of the hooks 34 and 42 could be stationary as shown in bottom hook of FIG. 1.

In any event, the electric cord 17 is wrapped around the hooks in a manner similar to that described above and then allowed to pass through a bottom portion of the pocket 46. In the embodiment shown in FIG. 3 the pocket has a single front wall 80 and single piece sidewalls 82 and 84. Each of the sidewalls also comprises a pair of clips 86 and 88. Only the clips on the right side wall 82 are shown in FIG. 3. Each of the clips 86 and 88 and the complimentary clips on the left sidewall are associated with apertures 90 and 92 in the base 18 as better shown in FIG. 4. In operation, the sidewalls 82 and 84 of the pocket 80 can be squeezed slightly so that the clips can move in the apertures and the pocket can be removed from the base. In this way, pockets 46 can be adapted for specific sizes of PEI, for example the Palm Pilot® shown in FIG. 3, can be easily substituted depending on the type of PEI that is owned by the user.

FIG. 4 shows a third embodiment of the invention. In this embodiment, the base acts as a cover for the electrical outlet similar to that shown in FIG. 3. Specifically, the base has a pair of major apertures 72 and 74 (not shown, hidden by the transformer 16) and a minor aperture 76 again for receiving a screw for holding the base 18 onto the electrical outlet and accordingly the wall. The mounting can be supplemented with a hook and loop fastener such as Velcro®.

In the FIG. 4 embodiment however, there is a pair of hooks and a pair of pockets for charging two PEI's simultaneously. The pockets are also shown having clips 86 and 88 and associated apertures 90 and 92 for mounting the respective pockets on the base. As can be appreciated, the pockets may be different and associated with specific sizes of PEI's.

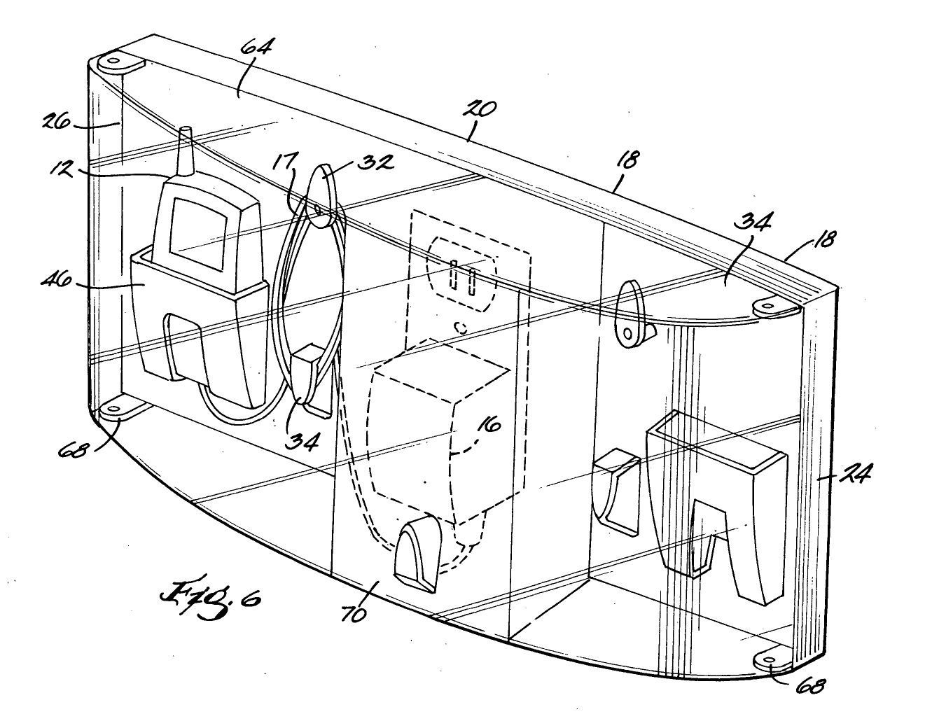

As seen in FIG. 5, the base 18 may have a varying cross section in thickness. The portion near the center for mounting on the electrical outlet 14 may be thin so that the transformers can mount properly onto the outlet. The outer sides may be thicker so that they can be more structurally rigid for mounting the hooks and pockets. In addition, an additional mounting aperture 94 may be provided on at least one or most preferably both sides of the base 18. In a preferred embodiment, the mounting aperture is hidden by the removable pocket 46 and extends through the base at a location behind the pocket front wall 80.

FIG. 6 shows another embodiment of the charging station 10. As in the embodiment shown in FIG. 4, this embodiment also provides for charging two PEI's simultaneously. Furthermore, this embodiment also discloses a cover 64 comprising three parts. On the outer left hand side and outer right side, the cover is allowed to swing open about hinges 68 that are located adjacent the left hand side 26 of the base and the right hand side 24 of the base respectively. These cover portions are preferably translucent or transparent so that the operator is aware of whether the PEI is being charged or not. The center portion of the cover is more permanently affixed to the base. For example, this cover could have clips and apertures similar to the clips and apertures described earlier for holding the pockets onto the base. The center portion of the cover is generally made of more an opaque plastic material so that the transformer and electrical outlet 14 is not visible to the operator. The center portion should also be vented or louvered in order to dissipate heat generated by the transformer. 16.

The embodiment shown in FIG. 7 is similar to the embodiments shown in FIGS. 4 and 6 in that it provides for charging a pair of PEI's simultaneously. It also provides for a cover that has two portions, an upper portion and a lower portion. The lower portion is generally opaque and covers the electrical outlets and transformers. The upper portion of the cover can be hinged 68 adjacent the upper edge 20 of the base 18 and is generally translucent or transparent so the user can see whether his PEI is being charged.

In all of the embodiments the third hook 70 may preferably be associated with the charger. As shown in FIGS. 3, 4 and 6, the third hook can be located on the pocket 46 or adjacent the wall 18 or on a cover 64. The third hook 70 can also extend outwardly from the wing of one of the hooks so the keys can be hung immediately adjacent to the electric cord. The third hook 70 can be covered by the cover 64 or be outside the cover, as in FIG. 6, to act as a more forceful reminder of the need to remember the items to be stored on the hook 70, such as a user's keys.

Since other changes and modifications varied to fit particular operating requirements and environments will be apparent to those skilled in the art, the invention is not considered limited to the examples chosen for purposes of illustration, and includes all changes and modifications which do not constitute a departure from the true spirit and scope of this invention as claimed in the following claims and equivalents thereto.

I claim:

1. A charging station for a portable electronic instrument having a charging cord comprising
a substantially planar base having a top and a bottom and a pair of sides and means for mounting said base on a wall,
a pocket mounted on said base, said pocket having a front wall and opposed sides walls,
a pair of spaced apart hooks, also mounted on the base adjacent the pocket, and
a cover, said cover being made of translucent or transparent material and hinged adjacent said top or bottom or one side of said base and swingable to allow access to said pocket.

2. The charging station of claim 1 further comprising an aperture in said base, said aperture adapted to allow the charging cord to pass there through.

3. The charging station of claim 1 further comprising a slot between said base and said cover, said slot adapted to receive the charging cord.

4. The charging station of claim 1 wherein one of said hooks has a stem projecting from said base and having a longitudinal axis and an arm extending at a substantially right angle from said stem, said stem rotatable about said longitudinal axis.

5. The charging station of claim 1 further comprising a third hook, said third hook adapted to hold keys.

6. The charging station of claim 1 wherein said pocket further comprises clips extending from said side walls and said base has apertures located to accept said clips for detachably mounting said pocket on said base.

7. The charging station of claim 1 further comprising an indicator light that signals the presence of a PEI in the charging station.

8. A charging station for a portable electronic device having a charging cord comprising a substantially planar base having a top, a bottom and a pair of side edges, at least one first major aperture and at least one second minor aperture, said apertures adapted to mount said base over an electrical outlet on a wall, a pair of spaced apart hooks mounted on said base and a pocket mounted on said base, said pocket having a front wall and opposed side walls and adapted to hold portable electronic instrument.

9. The charging station of claim 8 further comprising a cover, said cover being made of translucent or transparent material.

10. The charging station of claim 9 wherein said cover is hinged adjacent one of said base top or bottom or sides to allow access to said pocket.

11. The charging station of claim 8 wherein one of said hooks has a stem projecting from said base and having a longitudinal axis and an arm extending at a right angle from said stem, said stem rotatable about said longitudinal axis.

12. The charging station of claim 8 further comprising a third hook, said third hook adapted to hold keys.

13. The charging station of claim 8 wherein said pocket further comprises clips extending from said side walls and said base has apertures located to accept said clips, for detachably mounting said pocket on said base.

14. The charging station of claim 8 further comprising a pair of pockets and two pair of spaced apart hooks, one of said pockets and pair of spaced apart hooks on either side of said first and second apertures.

15. The charging station of claim 14 further comprising a cover, said cover having two hinges, one hinge adjacent each of said side walls.

16. The charging station of claim 15 wherein said cover halves extends over said pockets and said hooks, but not over said major and minor apertures.
